(19) United States
(12) Patent Application Publication
(10) Pub. No.: US 2019/0339093 A1
(43) Pub. Date: Nov. 7, 2019

(54) SYSTEM AND METHOD FOR VEHICLE WEATHER ADVISOR REAL-TIME NOTIFICATION

(71) Applicant: Honda Motor Co., Ltd., Tokyo (JP)

(72) Inventor: Richard Dean Strickland, Mooresville, NC (US)

(21) Appl. No.: 15/971,672

(22) Filed: May 4, 2018

(51) Int. Cl. G01C 21/36; G01W 1/00

(52) U.S. Cl. CPC G01C 21/3694; G01S 13/95; G01C 21/367; G01W 1/00

(57) ABSTRACT

According to one aspect, a computer implemented method associated with a weather advisor real-time notification for a vehicle is provided. The method includes receiving real-time weather data. The real-time weather data includes image-based weather data. The method also includes identifying a weather event based on pixel data associated with the image-based weather data. Binary masks having contours associated with the weather event are generated. The method further includes calculating a heading and speed of the weather event based on the binary masks. It is then determined whether the vehicle will intercept the weather event based on heading and speed of the weather event and route information of the vehicle.

### BACKGROUND

Weather is notoriously unpredictable. For example, despite a sunny day being forecasted, it may be raining. Moreover, forecasts are typically focused on a local area. Therefore, even if forecasts are accurate, a driver may incur unexpected weather conditions when traveling outside of the local area. Within a vehicle context, a vehicle occupant may be unknowingly on route to intercept a weather event, which can be inconvenient or pose an operational issue for the vehicle.

### BRIEF DESCRIPTION

According to one aspect, a computer implemented method associated with a weather advisor real-time notification for a vehicle is provided. The method includes receiving real-time weather data. The weather data includes image-based weather data. The method also includes identifying a weather event based on pixel data associated with the image-based weather data. Binary masks having at least one contour associated with the weather event are generated. The method further includes calculating a heading and speed of the weather event based on the binary mask. It is then determined whether the vehicle will intercept the weather event based on heading and speed of the weather event and route information of the vehicle.

According to another aspect, a system associated with a weather advisor real-time notification for a vehicle is provided. The system includes a vehicle having one or more vehicle systems, one or more vehicle sensors, and a processor. The processor is operably connected for computer communication to the one or more vehicle systems and the one or more vehicle sensors. The system also includes a data receiving module that receives real-time weather data from a weather service. The weather data includes at least one weather map image. The system further includes a weather event module that identifies a weather event based on colors of one or more pixels of the at least one weather map image. The system includes a binary mask module that generates at least one binary mask. The binary mask has at least one contour associated with the weather event. The binary mask module also assigns geographic coordinates to the at least one contour of the weather event. The system also includes an intercept module that determines whether the vehicle will intercept the weather event by calculating a heading and speed of the weather event based on the geographic coordinates and comparing the heading and speed to route information of the vehicle.

According to a further aspect, a computer implemented method associated with a weather advisor real-time notification for a vehicle is provided. The method includes receiving real-time weather data including radar images and a world coordinate system. A radar image has a plurality of color coded pixels. The method also includes identifying a weather event based on colors of one or more pixels of the radar images. The method further includes generating binary masks corresponding to the radar images. The binary masks have contours associated with the weather event. The method includes assigning the contours geographic coordinates based on the world coordinate system to define boundaries of the weather event. The method also includes calculating a heading and speed of the weather event based on the geographic coordinates of the binary masks. The method further includes determining whether the vehicle will intercept the weather event based on a heading and speed of the weather event and route information of the vehicle.

### BRIEF DESCRIPTION OF THE DRAWINGS

FIG. 1 is a schematic diagram of an operating environment for implementing systems and methods for vehicle weather advisor real-time notification according to an exemplary embodiment.

FIG. 2A is a schematic diagram of image-based weather data associated with a system for weather advisor real-time notification according to an exemplary embodiment.

FIG. 2B is a schematic diagram of a binary mask associated with a system for weather advisor real-time notification according to an exemplary embodiment.

FIG. 2C is a schematic diagram of an edge map having geographic coordinates associated with a system weather advisor real-time notification according to an exemplary embodiment.

FIG. 3 is a schematic view of a vehicle having a vehicle occupant and vehicle display according to an exemplary embodiment.

FIG. 4 is a process flow diagram of a method for vehicle weather advisor real-time notification according to an exemplary embodiment.

FIG. 5 is a schematic view of a vehicle display providing a weather notification and shelter information according to an exemplary embodiment.

### DETAILED DESCRIPTION

Generally, the systems and methods disclosed herein are directed to vehicle navigation integrating data from the vehicle with weather data to provide vehicle occupants weather notifications about upcoming weather events (e.g., a precipitation). A weather notification may include an estimated time to the vehicle intercepting the weather event, distance to the weather event, type of weather event (e.g., high winds, rain, snow, etc.), among others. In some embodiments, the weather notifications may further include weather avoidance information, such as shelter locations or vehicle information, for example, to close windows or secure the top of the vehicle.

### Definitions

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk,” as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “database,” as used herein can refer to table, a set of tables, a set of data stores and/or methods for accessing and/or manipulating those data stores. Some databases can be incorporated with a disk as defined above.

A “memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection,” or a connection by which entities are “operably connected,” is one in which signals, physical communications, and/or logical communications can be sent and/or received. An operable connection can include a wireless interface, a physical interface, a data interface, and/or an electrical interface.

A “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “portable device,” as used herein, is a computing device typically having a display screen with user input (e.g., touch, keyboard) and a processor for computing. Portable devices include, but are not limited to, handheld devices, mobile devices, smart phones, laptops, tablets, and e-readers. In some embodiments, a “portable device” could refer to a remote device that includes a processor for computing and/or a communication interface for receiving and transmitting data remotely.

A “vehicle,” as used herein, refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more human occupants and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle may or may not carry one or more human occupants. Further, the term “vehicle” can include vehicles that are automated or non-automated with pre-determined paths or free-moving vehicles.

A “vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

A “vehicle occupant,” as used herein can include, but is not limited to, one or more biological beings located in the vehicle. The vehicle occupant can be a driver or a passenger of the vehicle.

### System Overview

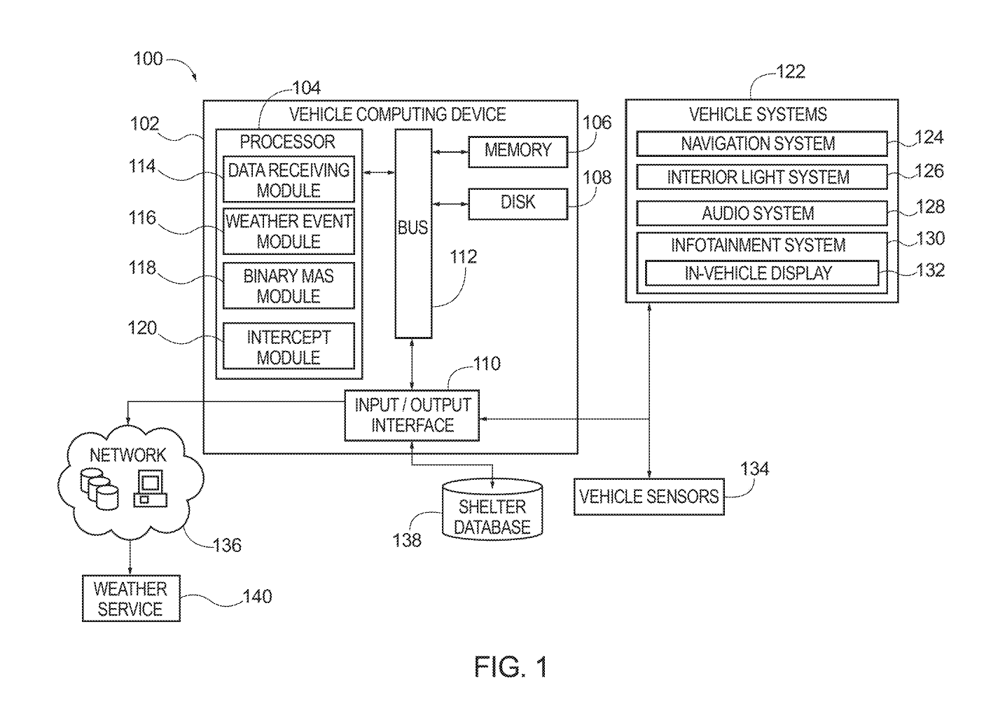

Referring now to the drawings, the showings are for purposes of illustrating one or more exemplary embodiments and not for purposes of limiting same, FIG. 1 is a schematic view of an operating environment 100 for implementing systems and methods for providing a vehicle weather real-time notification according to an exemplary embodiment. The components of the operating environment 100, as well as the components of other systems, hardware architectures, and software architectures discussed herein, may be combined, omitted, or organized into different architectures for various embodiments. Further, the components of the operating environment 100 can be implemented with or associated with a vehicle.

In the illustrated embodiment of FIG. 1, the operating environment 100 includes a vehicle computing device (VCD) 102 with provisions for processing, communicating and interacting with various components of a vehicle and other components of the operating environment 100. In one embodiment, the VCD 102 can be implemented with the vehicle, for example, as part of a telematics unit, a head unit, a navigation unit, an infotainment unit, an electronic control unit, among others. In other embodiments, the components and functions of the VCD 102 can be implemented remotely from the vehicle, for example, with a portable device (not shown) or another device connected via a network (e.g., a network 136).

Generally, the VCD 102 includes a processor 104, a memory 106, a disk 108, and an input/output (I/O) interface 110, which are each operably connected for computer communication via a bus 112 and/or other wired and wireless technologies. The I/O interface 110 provides software and hardware to facilitate data input and output between the components of the VCD 102 and other components, networks, and data sources, which will be described herein. Additionally, the processor 104 includes a data receiving module 114, a weather event module 116, a binary mask module 118, and an intercept module 120, that provide vehicle control for weather notification in real-time facilitated by the components of the operating environment 100.

The VCD 102 is also operably connected for computer communication (e.g., via the bus 112 and/or the I/O interface 110) to one or more vehicle systems 122. The vehicle systems 122 can include, but are not limited to, any automatic or manual systems that can be used to enhance the vehicle, driving, and/or safety. Here, the vehicle systems 122 include a navigation system 124, an interior light system 126, an audio system 128, and an infotainment system 130 according to an exemplary embodiment. The navigation system 124 stores, calculates, and provides route and destination information and facilitates features like turn-by-turn directions. The interior light system 126 controls lights interior to the vehicle, including, for example, dashboard lights. The audio system 128 controls audio (e.g., audio content, volume) in the vehicle. The infotainment system 130 provides visual information and/or entertainment, and can include an in-vehicle display 132.

The vehicle systems 122 include and/or are operably connected for computer communication to various vehicle sensors 134. The vehicle sensors 134 provide and/or sense information associated with the vehicle, the vehicle environment, and/or the vehicle systems 122. It is understood that the vehicle sensors 134 can include, but are not limited to, the vehicle sensors associated with the vehicle systems 122 and other vehicle sensors 134 associated with the vehicle. Specific vehicle system sensors can include, but are not limited to, environmental sensors, vehicle speed sensors, accelerator pedal sensors, brake sensors, throttle position sensors, wheel sensors, anti-lock brake sensors, camshaft sensors, among others. Other vehicle sensors 134 can include, but are not limited to, cameras mounted to the interior or exterior of the vehicle and radar and laser sensors mounted to the exterior of the vehicle. Further, vehicle sensors can include sensors external to the vehicle (accessed, for example, via the network 136), for example, external cameras, radar and laser sensors on other vehicles in a vehicle-to-vehicle network, street cameras, surveillance cameras, among others.

The vehicle sensors 134 are operable to sense a measurement of data associated with the vehicle, the vehicle environment, and/or the vehicle systems 122 and generate a data signal indicating said measurement of data. These data signals can be converted into other data formats (e.g., numerical) and/or used by the vehicle systems 122 and/or the VCD 102 to generate other data metrics and parameters. It is understood that the sensors can be any type of sensor, for example, acoustic, electric, environmental, optical, imaging, light, pressure, force, thermal, temperature, proximity, among others.

The VCD 102 is also operatively connected for computer communication to the network 136, and a shelter database 138. It is understood that the connection from the I/O interface 110 to the network 136, and the shelter database 138 can be facilitated in various ways. For example, through a network connection (e.g., wired or wireless), a cellular data network from a portable device (not shown), a vehicle to vehicle ad-hoc network (not shown), an in-vehicle network (not shown), among others, or any combination of thereof. It some embodiments, the shelter database 138 could be located on-board the vehicle, at for example, the memory 106 and/or the disk 108. Further, in some embodiments, the shelter database 138 could be located on a memory 106 or a disk 108. In other embodiments, the shelter database 138 can be distributed in one or more locations.

The network 136 is, for example, a data network, the Internet, a wide area network or a local area network. The network 136 serves as a communication medium to various remote devices (e.g., databases, web servers, remote servers, application servers, intermediary servers, client machines, other portable devices). In some embodiments, shelter database 138 may be included in the network 136, accessed by the VCD 102 through the network 136, and/or the network 136 can access the shelter database 138. Thus, in some embodiments, the VCD 102 can obtain data from shelter database 138 via the network 136.

The network 136 can also provide access between the VCD 102 and a weather service 140. The weather service 140 can include public and/or private weather service, weather alert systems, etc. In some embodiments, the VCD 102 can directly communicate with the weather service 140. Further, it is understood that in some embodiments, the weather service 140 can host the shelter database 138.

### Application of Systems and Methods

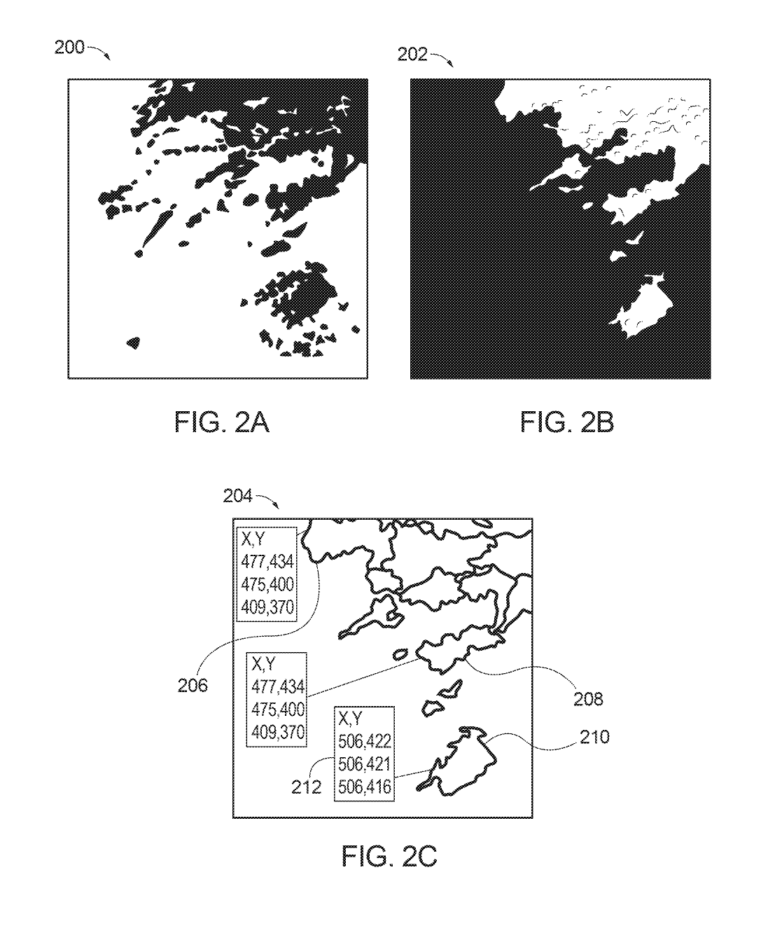

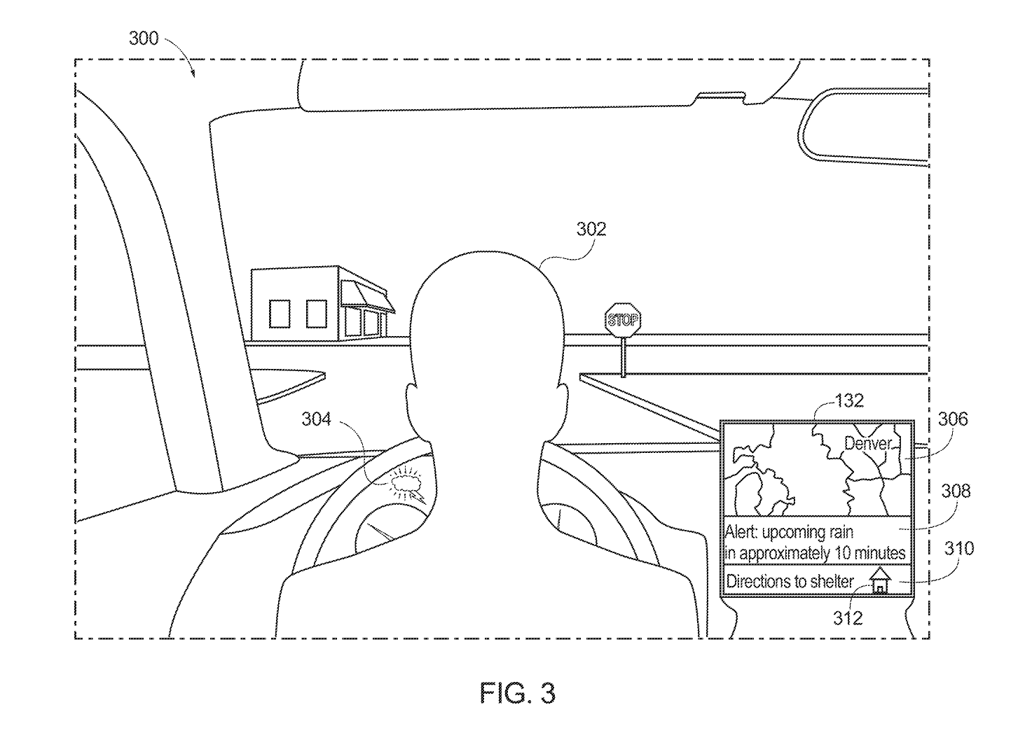

The system shown in FIG. 1 will now be described in operation according to an exemplary embodiment. FIG. 1 will be described with illustrative examples referring to FIGS. 2A, 2B, 2C, and 3. It is understood that the illustrative examples discussed herein are exemplary in nature and that other weather data, notifications, and vehicle control functions can be implemented.

As mentioned above, and as shown in detail in FIG. 3, the system includes a vehicle (e.g., the vehicle 300 of FIG. 3), with one or more vehicle systems 122 and one or more vehicle sensors 134. The vehicle 300 also includes the processor 104. The data receiving module 114 of the processor 104 receives real-time weather data from the weather service 140.

The real time weather data may be based on the location of the vehicle 300. For example, the real time weather data may be for an area centered on the location of the vehicle 300. The location of the vehicle 300 can be based on data from the vehicle systems 122 and/or the vehicle sensors 134. For example, the data receiving module 114 may use information from the navigation system 124 of the vehicle system 122 to identify the location of the vehicle 300. In some embodiments, the data receiving module 114 may define the area as having a predetermined radius centered on the location of the vehicle 300.

The weather data can include, but is not limited to, image-based weather data such as, radar images and weather (e.g., precipitation, field, temperature, etc.) maps, as well as temperature, precipitation, and drought records, climatic data, regional and global indexes, and associated files. The associated files may be data or metadata about the weather data. For example, a radar image may have a world coordinate conversion file that is a world coordinate interface that correlates the size of the radar image in pixels to the world coordinate system, such as geographic coordinates (e.g., latitude, longitude). In particular, the world coordinate conversion file may include dimensional data: X-dimension of a pixel in map units, negative of Y-dimension of a pixel in map units, a rotation parameter, X-world coordinate of center of upper left pixel, and a Y world coordinate of center of upper left pixel. This dimensional data can be used to calculate corresponding geographic coordinates from the image-based weather data.

Referring again to the operation of the system shown in FIG. 1, weather event module 116 of the processor 104 identifies a weather even based on the weather data received at the data receiving module 114. A “weather event” as used herein can be any atmospheric condition that may impact the vehicle, driving the vehicle, and/or safety of a vehicle occupant. For example, a weather event can be precipitation (e.g., light rain, steady rain, thunderstorm, snow, hail, sleet, blizzard, etc.), hurricane, high winds, fog, wildfire, sand-storm, tornadoes, avalanche, among others.

In one embodiment, the weather event module 116 uses the processor 104 for image processing of image-based weather data. For example, suppose that the weather data is a series of weather map images of a region, each weather map image in the series being taken at a different time. An exemplary weather map image 200 is illustrated in FIG. 2A. The weather map images are processed based on pixel data, such as the color values of the pixels or the pixel color. For example, the pixel data may be used to identify the color value of each pixel in the weather map images. A weather event is identified based on the color value of the pixels. The weather map images may be color coded such that different weather events are prescribed different colors. For example, pixels having a specific color value or a range of color values may be identified as representing a weather event. Accordingly, pixels can be grouped based on pixel color value, and the group of pixels is identified as a weather event.

In some embodiments, the color values may vary by the intensity of the weather event. For example, suppose that the weather event is rain, a color value associated with greens may indicate light rain, a color value associated with yellows may indicate moderate rain, and a color value associated with reds may indicate heavy rain. In this example, intervening color values may indicate rain falling with an intensity between light, moderate, and heavy. For example, a color value associated with oranges may indicate rain falling with an intensity between moderate and heavy.

In some embodiments, the weather service 140 provides standardized definitions of color values for image-based weather data. For example, the weather service 140 may provide data defining color values corresponding to greens are indicative of rain or color values corresponding to pink are indicative of snow. In some embodiments, the definition of pixel color values may be included with metadata for the image-based weather data. The weather event module 116 may then correlate the definition of colors provided by the weather service 140 to color values of the image-based weather data during image processing. In yet other embodiments, the weather event module 116 may access an independent set of color definitions or color value definitions may be stored on the VCD 102 or associated with the vehicle systems 122, such as the navigation system 124.

As discussed above, the weather event module 116 groups pixels based on pixel color and the group is identified as a weather event. In some embodiments, the weather event module 116 may group pixels based on a range of color values. In another embodiment, the weather event module 116 may group pixels into a plurality of groups corresponding to different weather different events based on color value, the pixels proximity to one another (i.e., clustering), or other metrics.

In some embodiments, the weather event module 116 identifies pixels by pixel color or color value based on a selected weather type. For example, a vehicle occupant may select a particular weather type. Accordingly, the weather event module 116 may selectively identify pixels having the pixel color in the range associated with the weather type. suppose that a vehicle occupant may wish to only receive notifications regarding heavy rain. As discussed above, red may indicate heavy rain, accordingly, the weather event module 116 may only identify weather events associated with one or more pixels having a red pixel color/color value.

The binary mask module 118 of the processor 104 forms one or more binary masks corresponding to weather events identified by the weather event module 116. An example binary mask 202 corresponding to the example weather map image 200 is shown in FIG. 2B. A binary mask corresponds to weather data. For example, each weather map image in the set of weather map images could be used to generate a binary mask. The binary mask is a dichromatic representation of the weather data. For example, a first color, white for example, is used to represent pixels associated with the weather event and a second color, black for example, is used to represent the remainder of the pixels or ambient atmosphere.

The binary mask module 118 performs edge detection on the one or more binary masks to determine the border between the first color and second color and generates an edge image that defines the contours (i.e., boundaries) of the weather event. An example edge map 204 corresponding to the example binary mask 202 is shown in FIG. 2C. The example edge map 204 has a plurality of contours including contours 206, 208, and 210. The binary mask module 118 also calculates a center of the weather event and at least one point on the contour of the weather event as an array of coordinates 212. For example, the binary mask module 118 may calculate an array of Cartesian coordinates corresponding contours or points interior to the weather event. In some embodiments, the binary mask module 118 may define a plurality of contours for a single weather event or contours corresponding to different weather events.

The intercept module 120 determines whether the vehicle 300 is on a route to intercept the weather event. The intercept module 120 calculates weather event tracking data (e.g., geographic location, heading, speed, etc.). For example, the intercept module 120 can convert the array of coordinates, such as Cartesian coordinates, calculated by the binary mask module 118 into geographic coordinates according to the weather data. For example, as discussed above, the weather data may include the world coordinate conversion file for converting the array of coordinates into geographic coordinates including longitude and latitude. Furthermore, the image-based weather data can be processed sequentially to determine the velocity, including heading and speed, of the weather event. A series of weather map images may be processed in chronological order, based on a timestamp or metadata, to determine the velocity, including heading and speed, of the weather event shown in the image-based weather data.

The intercept module 120 also calculates the route of the vehicle 300. The route may be based on information received from the vehicle system 122 and/or the vehicle sensors 134. For example, the route of the vehicle may be determined based on the information retrieved the navigation system 124. Additionally or alternatively, the route information may be based on sensor data retrieved from the vehicle sensors 134 to determine the heading and speed of the vehicle 300. For example, the vehicle systems 122 and/or vehicle sensors 134 may provide global positioning system (GPS) location data, speed data, etc.

The intercept module 120 uses the weather event tracking data and the route of the vehicle 300 to determine whether the vehicle 300 will intercept the weather event. For example, the intercept module 120 may determine dynamic estimates for when and where the vehicle 300 will encounter the weather event based on the distance from the nearest weather event contour to the location of the vehicle 300.

If it is determined that the vehicle 300 will intercept the weather event, the intercept module 120 generates a notification for the vehicle occupant 302 shown in FIG. 3. The notification may include information about the weather event, information about shelter, or vehicle information. For example, based on data from the vehicle systems 122 or the vehicle sensors 134, the intercept module 120 may determine the top of the vehicle 300 or windows of the vehicle 300 are down, and thus, may create a notification including vehicle information, for example, to close windows or secure the top of the vehicle.

The notification may be a visual cue, audio cue, among others. For example, the intercept module 120 can cause the interior light system 126 of the vehicle systems 122 to notify the vehicle occupants that a weather event is imminent. For example, the interior light system 126 may cause a light, such as a dashboard light 304 shown FIG. 3, to be illuminated. The color of the dashboard light 304 may be based on the weather type (i.e., the type of weather event), intensity, or proximity of the weather event. In some embodiments, the dashboard light 304 may be illuminated in a pattern to indicate the proximity of the weather event. For example, the dashboard light 304 may blink with increasing frequency as the vehicle 300 approaches the weather event.

In another embodiment, the intercept module 120 can control the audio system 128 to provide a notification as an audio cue. For example, the audio cue may be musical sounds, a spoken alert, or combination thereof. The volume or type of audio cue may be based on based on the type, intensity, or proximity of the weather event. A musical sound includes, beeps, honks, chirps, among others. A spoken alert may include a voice stating that the vehicle is on route to intercept a weather event. Additionally or alternatively, the spoken alert may include information regarding the weather event, such as the type of weather event, estimated time to intercept, shelter information, etc.

Shelter information is information about places that offer protection from the weather event. A shelter is any place and/or object that provides protection from the local environment, including the weather event, on at least one side. For example, a shelter may be an area under an overpass, a building (e.g., gas station, convenience store, rest stop, telephone booth, covered bus stop, etc.), one-sided structure (e.g., picnic shelter, lean-to, etc.) among others.

The intercept module 120 may execute a query at the shelter database 138 for shelter information. The shelter database 138 can return shelter information including one or more of the type of shelter, geographic location of the shelter, directions to the shelter, availability of the shelter (e.g., open hours), images of the shelter, etc. In some embodiments, the shelter database returns shelter information to the intercept module 120, and the intercept module 120 uses the shelter information to calculate additional shelter information. For example, suppose that the shelter database 138 returns shelter information including a type of shelter, geographic location of the shelter, and the availability of the shelter. The intercept module 120 may use this information to calculate additional shelter information including directions to the shelter and the estimated time of arrival. In some embodiments, the intercept module 120 may retrieve information from the vehicle systems 122, such as the navigation system 124, and/or vehicle sensors 134 to calculate the additional shelter information based on the shelter information received from the shelter database 138.

In a further embodiment, the intercept module 120 may control the infotainment system 130 to cause the in-vehicle display 132 to display a notification as shown in FIG. 3. The in-vehicle display 132 may show a weather map 306 illustrating the weather event, a notification 308 that identifies a type of weather event and approximate time and/or distance to intercept the weather event, and shelter information 310. In some embodiments, shelter information may be represented by a shelter icon 312. The information displayed on the in-vehicle display 132 can be accompanied by audio cues from the audio system 128.

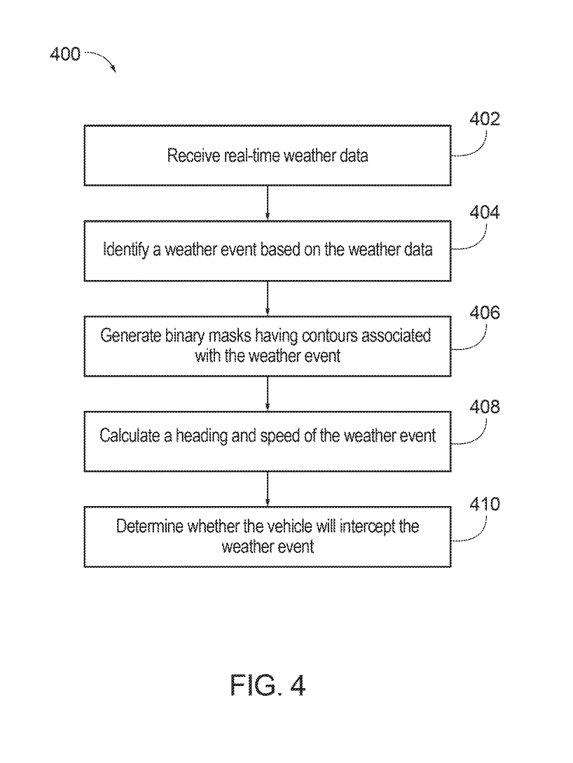

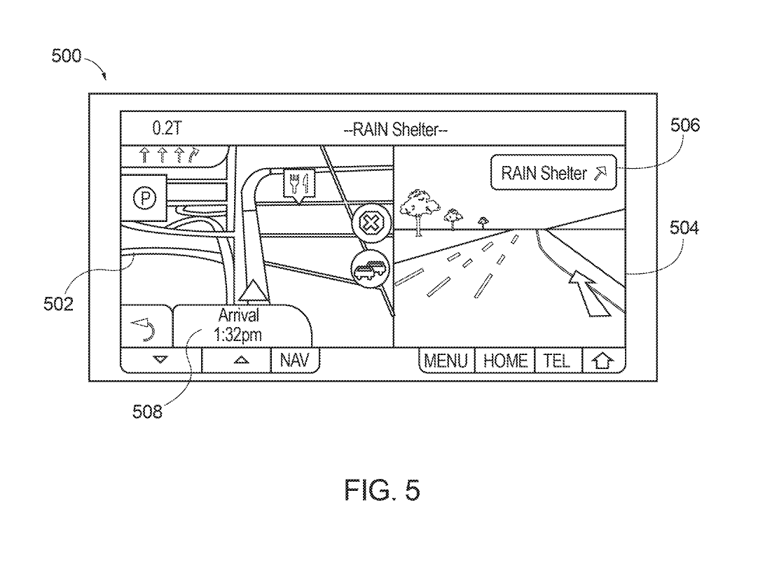

Referring now to FIG. 4, a method for weather advisories and real-time notifications according to an exemplary embodiment will be described. FIG. 4 will be described with reference to the components of FIGS. 1, 2A, 2B, 2C, and 3. Additionally, FIG. 4 will be described with illustrative examples referring to FIG. 5. It is understood that the illustrative examples discussed herein are exemplary in nature and that other weather data, notifications, and vehicle control functions can be implemented.

With references to FIG. 4, at block 402, the method includes receiving real-time weather data. The weather data may include image-based weather data such as weather map images or radar images. The weather data may additionally include information about the image-based weather data, such as a world coordinate system. Because weather changes and the vehicle may be changing location, the data receiving module 114 of the processor 104 may receive updated real-time weather data from the weather service 140. For example, the data receiving module 114 may receive information from the weather service 140 according to a schedule. In one embodiment, the data receiving module 114 may receive information every five minutes or every ten miles driven. Additionally or alternatively, the data receiving module 114 may query the weather service 140 based on information received from the vehicle systems 122 or the vehicle sensors 134. In one embodiment, the data receiving module 114 may query the weather service 140 when the vehicle 300 travels to predetermined locations according to the navigation system 124. In another embodiment, the data receiving module 114 may query the weather service 140 based on data from the vehicle systems 122. For example, the data receiving module may query the weather service 140 when the vehicle sensors 134, such as an environmental sensor detecting a threshold amount of moisture in the air, a barometric drop in pressure, light levels, wind speeds, etc.

The image-based weather data may include a plurality of color coded pixels. The pixels are color coded such that a weather event can be differentiated from ambient atmosphere. For example, a weather event may be represented by green pixels whereas the ambient atmosphere is represented by blue pixels. In some embodiments, the pixels are further color coded so that different types of weather events can be differentiated from one another.

At block 404, the method includes identifying a weather event based on the image-based weather data. For example, the weather event may be based on colors of one or more pixels of the image-based weather data. Accordingly, the weather event module 116 can identify the weather event based on color coding of the pixels. For example, the weather event module 116 may perform image processing to differentiate between the colors of the pixels. In one embodiment, the weather event module 116 accesses the metadata for the image-based weather data to identify the weather event.

At block 406, the method includes generating binary masks corresponding to the image-based weather data. The binary mask module 118 generates binary masks corresponding to the image-based weather data. As discussed above, a binary mask is a dichromatic representation of the image-based weather data such that each weather event is represented by a contour that outlines the boundary of the weather event. Therefore, a radar image illustrating a plurality of weather events will correspond to a binary mask having a plurality of contours.

In some embodiments, the contours of the binary masks are assigned geographic coordinates based on the world coordinate system to define boundaries of the weather event. To do this, the binary mask module 118 can create an edge map. The binary mask module 118 uses image processing techniques, such as edge detection to define the contours of the weather event and weather data, such as the world coordinate system, to assign the geographic coordinates to the contours. In some embodiment, the binary mask module 118 also identifies an approximate center point of the weather event.

At block 408, the method includes calculating a heading and speed of the weather event based on the geographic coordinates of the contours. The intercept module 120 may compare the geographic coordinates of the contours based on the timestamp of the image-based weather data to determine the heading and speed of the weather event.

At block 410, the method includes determining whether the vehicle 300 will intercept the vehicle will intercept the weather event based on the heading and the speed of the weather event and route information of the vehicle 300. The intercept module 120 may calculate the route information of the vehicle 300 from the vehicle systems 122 and/or the vehicle sensors 134. The intercept module 120 compares the heading and speed of the weather event to the route information to determine whether the vehicle 300 will encounter the weather event. In one embodiment, the determination is made by finding an intersection point graphically or algebraically. Based on the determination, the intercept module 120 may generate a notification to alert the vehicle occupant to weather event in real-time. The notification may include shelter information so that the driver occupant can choose to take shelter from the imminent weather event.

In some embodiments, the vehicle occupant 302 may select to see more about shelter information 310 the in-vehicle display 132 may provide directions 500 to the shelter as shown in FIG. 5. In one embodiment, the directions 500 are shown on the in-vehicle display 132 in response to the shelter icon 312 being selected. In another embodiment, a notification of a weather event may automatically cause the in-vehicle display 132 to show the directions 500 to the shelter. The directions 500 may include a direction map 502, a virtual image 504 of the roadway, a shelter definition 506, and an estimated time of arrival 508 to the shelter. Accordingly, a system weather advisor real-time notification is described that notifies vehicle occupants of imminent weather events so that the vehicle occupants can take shelter if desired.

The embodiments discussed herein may also be described and implemented in the context of non-transitory computer-readable storage medium storing computer-executable instructions. Non-transitory computer-readable storage media includes computer storage media and communication media. For example, flash memory drives, digital versatile discs (DVDs), compact discs (CDs), floppy disks, and tape cassettes. Non-transitory computer-readable storage media may include volatile and nonvolatile, removable and non-removable media implemented in any method or technology for storage of information such as computer readable instructions, data structures, modules, or other data. Non-transitory computer readable storage media excludes transitory and propagated data signals.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method associated with a weather advisor real-time notification for a vehicle, comprising:
receiving real-time weather data, wherein the real-time weather data includes image-based weather data;
identifying a weather event based on pixel data associated with the image-based weather data;
generating a binary mask having at least one contour associated with the weather event, calculating a heading and speed of the weather event based on the binary mask; and
determining whether the vehicle will intercept the weather event based on heading and speed of the weather event and route information of the vehicle.

2. The computer-implemented method of claim 1, wherein the at least one contour represents an area occupied by the weather event.

3. The computer-implemented method of claim 1, wherein the pixel data includes information about color-coded pixels having a pixel color in a range based on a weather type, the method further comprising:
selecting the weather type, wherein identifying the weather event is based on identifying pixels having the pixel color in the range associated with the weather type.

4. The computer-implemented method of claim 3, wherein the binary mask has a first color representing the color-coded pixels of the image-based weather data with the pixel color in the range and a second color representing the color-coded pixels of the image-based weather data with the pixel color outside of the range.

5. The computer-implemented method of claim 3, wherein the weather type is rain, and wherein the range includes reds, yellows, and greens.

6. The computer-implemented method of claim 1, wherein generating the binary mask includes detecting the at least one contour and assigning geographic coordinates to the at least one contour.

7. The computer-implemented method of claim 6, wherein the geographic coordinates assigned to the at least one contour are based on Cartesian coordinates calculated from the real-time weather data.

8. The computer-implemented method of claim 1, further including generating a notification based on the weather event.

9. The computer-implemented method of claim 8, wherein the notification includes a weather type, a distance to the weather event, and shelter information.

10. The computer-implemented method of claim 9, wherein the shelter information includes a type of shelter and directions to a shelter.

11. A system associated with a weather advisor real-time notification, comprising:
a vehicle including one or more vehicle systems, one or more vehicle sensors and a processor, the processor operably connected for computer communication to the one or more vehicle systems and one or more vehicle sensors;
a data receiving module configured to receive weather data from a weather service, wherein the weather data includes at least one weather map image;
a weather event module identifies a weather event based on colors of one or more pixels of the at least one weather map image;
a binary mask module generates at least one binary mask, having at least one contour associated with the weather event, the at least one binary mask corresponding to the at least one weather map image, and assigns the at least one contour geographic coordinates to the at least one contour of the weather event; and
an intercept module configured to determine whether the vehicle will intercept the weather event by calculating a heading and speed of the weather event based on the geographic coordinates of the at least one binary mask and comparing the heading and speed to route information of the vehicle.

12. The system of claim 11, wherein the binary mask module assigns the geographic coordinates based on a world coordinate system.

13. The system of claim 11, wherein the intercept module further generates a notification based on the weather event when the intercept module determines that the weather event will intercept the vehicle.

14. The system of claim 13, wherein the notification includes directions to a shelter having a direction map, a virtual image of a roadway, a shelter definition, and an estimated time of arrival to the shelter.

15. A computer-implemented method associated with a weather advisor real-time notification for a vehicle, comprising:
receiving real-time weather data including radar images and a world coordinate system, wherein a radar image has one or more color coded pixels;
identifying a weather event based on colors of the one or more color coded pixels of the radar images;
generating binary masks corresponding to the radar images, wherein the binary masks have contours associated with the weather event, assigning the contours geographic coordinates based on the world coordinate system to define boundaries of the weather event;
calculating a heading and speed of the weather event based on the geographic coordinates of the binary masks; and
determining whether the vehicle will intercept the weather event based on the heading and the speed of the weather event and route information of the vehicle.

16. The computer-implemented method of claim 15, wherein the one or more color coded pixels are color coded based on weather type, the method further comprising:
selecting a weather type, wherein identifying the weather event is based on identifying pixels having color in a range associated with the weather type.

17. The computer-implemented method of claim 16, wherein a binary mask of the binary masks has a first color representing the one or more color coded pixels of the radar image with a color in the range and a second color representing the one or more color coded pixels of the radar image with a color outside of the range.

18. The computer-implemented method of claim 17, wherein the weather type is rain, and wherein the range includes reds, yellows, and greens.

19. The computer-implemented method of claim 15, wherein generating the binary masks includes detecting the contours and assigning the contours with Cartesian coordinates.

20. The computer-implemented method of claim 15, the method further comprising generating a notification based on the weather event, wherein the notification includes a weather type, a distance to the weather event, and shelter information.
